(19) United States
(12) Patent Application Publication
(10) Pub. No.: US 2025/0303754 A1
(43) Pub. Date: Oct. 2, 2025

(54) RECORDING APPARATUS, CONTROL METHOD OF RECORDING APPARATUS, AND MEDIUM

(71) Applicant: BROTHER KOGYO KABUSHIKI KAISHA, Nagoya (JP)

(72) Inventors: Isao KOBAYASHI, Nagoya (JP); Yusuke ARAI, Nagoya (JP); Hiroaki TAKAHASHI, Nagoya (JP)

(73) Assignee: BROTHER KOGYO KABUSHIKI KAISHA, Nagoya (JP)

(21) Appl. No.: 19/083,168

(22) Filed: Mar. 18, 2025

(30) Foreign Application Priority Data
Mar. 28, 2024 (JP) 2024-054939

(51) Int. Cl. B41J 11/66; B41J 11/70

(52) U.S. Cl. CPC B41J 11/663; B41J 11/70

(57) ABSTRACT

There is provided a recording apparatus including: a recorder; a cutter; a conveyor; and a controller. A cutting position is located upstream of the recorder in a first conveyance route. The controller is configured to execute first control to generate a first recorded item being a first medium on which a first image is recorded and a second recorded item being a second medium on which a second image is recorded. The first control includes: a first recording process of causing the recorder to record the first image and the second image on a first objective recording medium; a first conveying process of causing the conveyor to convey the first objective recording medium after the first recording process; and a first cutting process of causing the cutter to cut the first objective recording medium after the first conveying process.

### REFERENCE TO RELATED APPLICATIONS

This application claims priority from Japanese Patent Application No. 2024-054939 filed on Mar. 28, 2024. The entire content of the priority application is incorporated herein by reference.

### BACKGROUND ART

A configuration is known wherein a cutter (cutting part) is disposed downstream of a sheet feed cassette in a conveyance route, in a sheet feeding part which feeds a sheet to an image forming apparatus (recording apparatus). The sheet taken out of the sheet feed cassette is cut and divided by the cutter. A recording part of the image forming apparatus records an image on the divided sheet(s).

### SUMMARY

In a case where the cutter cuts the recording medium, a load is applied to the recording medium, which might deviate the position of the recording medium. In the above-described configuration, the image is recorded after the recording medium is cut, and thus the image is recorded on the recording medium of which position has been deviated due to the cutting, which might degrade the quality of the image.

An object of the present disclosure is to provide a recording apparatus, a control method of a recording apparatus and a medium each of which can reduce the degradation in the image quality in the configuration with a recording part and a cutting part.

According to a first aspect of the present disclosure, there is provided a recording apparatus including:
a recorder configured to record an image on a recording medium;
a cutter configured to cut the recording medium at a cutting position so as to divide the recording medium into a first medium and a second medium;
a conveyor configured to convey the recording medium toward the recorder along a first conveyance route; and
a controller, wherein:
the cutting position is located upstream of the recorder in the first conveyance route;
the controller is configured to execute first control so as to generate a first recorded item being the first medium on which a first image is recorded and a second recorded item being the second medium on which a second image is recorded; and
the first control includes:
   a first recording process of causing the recorder to record the first image and the second image on a first objective recording medium being the recording medium which is single and which is an object of the first control;
   a first conveying process of causing the conveyor to convey the first objective recording medium so that a cutting planned position of the first objective recording medium is located at the cutting position after the first recording process; and
   a first cutting process of causing the cutter to cut the first objective recording medium after the first conveying process.

According to a second aspect of the present disclosure, there is provided a control method of a recording apparatus, the recording apparatus including:
a recorder configured to record an image on a recording medium;
a cutter configured to cut the recording medium at a cutting position so as to divide the recording medium into a first medium and a second medium; and
a conveyor configured to convey the recording medium toward the recorder along a first conveyance route,
wherein the cutting position is located upstream of the recorder in the first conveyance route,
the control method including executing first control so as to generate a first recorded item being the first medium on which a first image is recorded and a second recorded item being the second medium on which a second image is recorded,
wherein the first control includes:
   a first recording process of causing the recorder to record the first image and the second image on a first objective recording medium being the recording medium which is single and which is an object of the first control;
   a first conveying process of causing the conveyor to convey the first objective recording medium so that a cutting planned position of the first objective recording medium is located at the cutting position after the first recording process; and
   a first cutting process of causing the cutter to cut the first objective recording medium after the first conveying process.

According to a third aspect of the present disclosure, there is provided a non-transitory and computer-readable medium storing a program executable by a controller of a recording apparatus, the recording apparatus including:
a recorder configured to record an image on a recording medium;
a cutter configured to cut the recording medium at a cutting position so as to divide the recording medium into a first medium and a second medium;
a conveyor configured to convey the recording medium toward the recorder along a first conveyance route; and
the controller,
wherein the cutting position is located upstream of the recorder in the first conveyance route,
the program is configured to cause the controller to execute first control so as to generate a first recorded item being the first medium on which a first image is recorded and a second recorded item being the second medium on which a second image is recorded,
wherein the first control includes:
   a first recording process of causing the recorder to record the first image and the second image on a first objective recording medium being the recording medium which is single and which is an object of the first control;
   a first conveying process of causing the conveyor to convey the first objective recording medium so that a cutting planned position of the first objective recording medium is located at the cutting position after the first recording process; and
   a first cutting process of causing the cutter to cut the first objective recording medium after the first conveying process.

According to the present disclosure, the cutting position is located upstream of the recording part in the first conveyance path. In this configuration, the image is recorded in the first control before the cutting. In this case, since the recording medium has not undergone any positional deviation due to the cutting in a case that the recording is performed, degradation of quality of the image is reduced.

### BRIEF DESCRIPTION OF DRAWINGS

FIG. 1 is a perspective view of a printer.

FIG. 2 is a vertical cross-sectional view depicting an internal structure of the printer of FIG. 1.

FIG. 3 is a block diagram depicting an electrical configuration of the printer of FIG. 1.

FIG. 4A and FIG. 4B are flow charts indicating a program executed by a CPU of the printer of FIG. 1.

FIG. 5A is a schematic view depicting step S5 of FIG. 4A.

FIG. 5B is a schematic view depicting step S6 of FIG. 4A.

FIG. 5C is a schematic view depicting step S7 of FIG. 4B.

FIG. 5D is a schematic view depicting step S8 of FIG. 4B.

FIG. 6A is a schematic view depicting step S5 of FIG. 4A.

FIG. 6B is a schematic view depicting step S7 of FIG. 4B.

FIG. 6C is a schematic view depicting step S8 of FIG. 4B.

FIG. 7 is a vertical cross-sectional view depicting an internal structure of a printer.

FIG. 8 is a vertical cross-sectional view depicting an internal structure of a printer.

### DESCRIPTION

### Embodiment

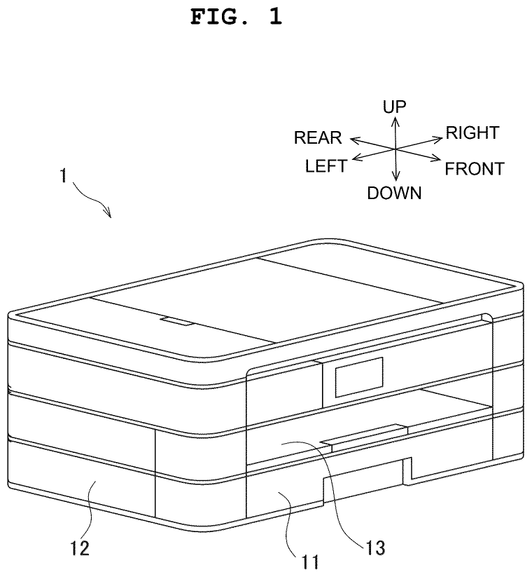

A printer 1 depicted in FIG. 1 is a first embodiment of a “recording apparatus”. In the following description, the respective directions of the printer 1 which are an up-down direction, a left-right direction and a front-rear direction are defined based on a state of FIG. 1 in which the printer 1 is disposed to be usable.

As depicted in FIG. 1, the printer 1 has a casing 12 having a shape of a substantially rectangular parallelepiped, a sheet feed tray 11 disposed in a lower part of the casing 12, and a sheet discharge tray 13 disposed above the sheet feed tray 11 in the inside of the casing 12.

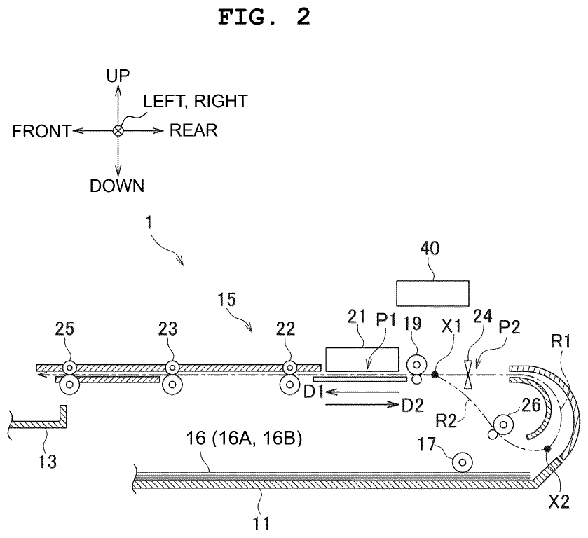

The sheet feed tray 11 is detachable and attachable with respect to the casing 12. As depicted in FIG. 2, the sheet feed tray 11 can accommodate a plurality of sheets 16, and can accommodate sheets 16 of a plurality of sizes. The plurality of sizes includes A4 size and A5 size, and lengths in the front-rear direction of the sheets 16 in a case where the sheets 16 having different sizes are placed in the sheet feed tray 11 are mutually different. The sheet 16 is an example of a “recording medium”. The sheet feed tray 11 is an example of a “container”.

The sheet 16 has a front surface 16A and a back surface 16B opposite the front surface 16A. The front surface 16A is an example of a “first surface”, and the back surface 16B is an example of a “second surface”. In the sheet feed tray 11, the sheet 16 is disposed so that the front surface 16A faces downward.

The printer 1 has a recording unit 21, a cutting unit 24, a conveying unit 15, and a control unit 40 inside the casing 12. The recording unit 21 is an example of a “recorder”. The cutting unit 24 is an example of a “cutter”. The conveyance unit 15 is an example of a “conveyor”.

The recording unit 21 is of an ink-jet system, and includes an ink channel having a plurality of nozzles, and a driver IC. The plurality of nozzles is open in the lower surface of the recording unit 21. In a case where the driver IC is driven under the control of the control unit 40, pressure is applied to the ink channel, and an ink droplet is ejected from the nozzle. As a result, the ink droplet lands on the sheet 16 located at a recording position P1, and an image is recorded on the sheet 16. The recording position P1 is defined below the recording unit 21. The recording unit 21 may be either of a line system or a serial system.

The cutting unit 24 has a cutting blade and a cutting motor. The cutting blade includes a fixed blade and a rotary blade. In a case where the cutting motor is driven under the control of the control unit 40, the rotary blade moves in the left-right direction while rotating. As a result, the sheet 16 is cut at a cutting position P2 and is divided into a first half part and a second half part. The cutting position P2 is a position at which the rotary blade moves in the left-right direction in a state that the rotary blade is in contact with the fixed blade.

The conveying unit 15 conveys the sheet 16 along a first conveyance route R1 toward the recording unit 21. The first conveyance route R1 spans from the sheet feed tray 11 to the sheet discharge tray 13, via the cutting position P2 and the recording position P1.

The conveying unit 15 is capable of performing first conveyance and second conveyance.

The first conveyance is a conveyance of the sheet 16 along the first conveyance route R1 so that the front surface of the sheet 16 faces upward (faces the recording unit 21) at the recording position P1.

The second conveyance is a conveyance of the sheet 16 from the first conveyance route R1 to the first conveyance route R1 via a second conveyance route R2, so that the sheet 16 is changed from a state that the front surface of sheet 16 face upward at the recording position P1 to a state that the back surface of the sheet 16 faces upward at the recording position P1.

The second conveyance route R2 branches from the first conveyance route R1 at a branching point X1 in the first conveyance route R1 and joins the first conveyance route R1 at a joining point X2 in the first conveyance route R1. The branching point X1 is located upstream of the recording unit 21 in the first conveyance route R1 and downstream of the cutting position P2 in the first conveyance route R1. The joining point X2 is located upstream of the branching point X1 and the cutting position P2 in the first conveyance route R1.

The cutting position P2 is located upstream of the recording unit 21 in the first conveyance route R1. A distance from the recording unit 21 to the cutting position P2 in the first conveyance route R1 is smaller than a half of a length along the first conveyance route R1 of a sheet 16 having a length along the first conveyance route R1 which is greatest among the plurality of sizes of the sheets 16 accommodatable in the sheet feed tray 11. For example, the distance is 182 mm or less. Note that, the distance from the recording unit 21 to the cutting position P2 may be, for example, a distance along the first conveyance route R1 from a position of a nozzle, among the plurality of nozzles of the recording unit 21, disposed upstream-most in a first direction D1 (described below) to the cutting position P2.

The conveying unit 15 includes a sheet feeding roller 17, conveying roller pairs 19, 22, 23, 25 and 26, and a conveying motor. The sheet feeding roller 17 and the conveying roller pairs 19, 22, 23, 25 and 26 are rotated by the driving of the conveying motor.

The sheet feeding roller 17 is positioned so as to contact the back surface 16B of an uppermost sheet 16 among the plurality of sheets 16 accommodated in the sheet feed tray 11.

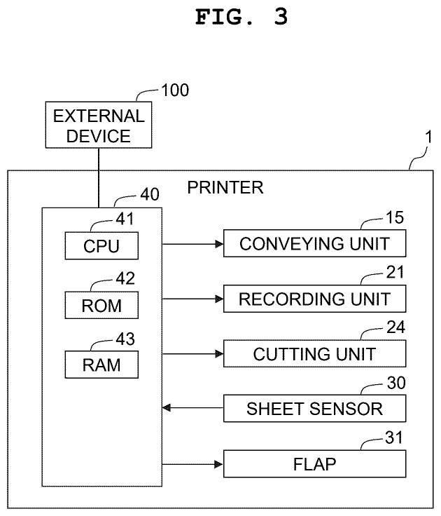

At the branching point X1, a sheet sensor 30 and a flap 31 depicted in FIG. 3 are disposed. The sheet sensor 30 transmits, to the control unit 40, an ON signal indicating that a sheet 16 is present at the branching point X1, or an OFF signal indicating that the sheet 16 is not present at the branching point X1. The flap 31 can be located at an entered position at which the flap 31 has entered the first conveyance route R1, or a retracted position at which the flap 31 has retracted from the first conveyance route R1. In a case where the flap 31 is located at the entered position, the sheet 16 cannot pass through the first conveyance route R1. In a case where the flap 31 is located at the retracted position, the sheet 16 can pass through the first conveyance route R1.

In a case where the conveying unit 15 performs the first conveyance, the flap 31 is held at the retracted position. In a case where the conveying motor is driven under the control of the control unit 40, the sheet feeding roller 17 rotates to thereby feed the uppermost sheet 16 included in the plurality of sheets 16 stored in the sheet feed tray 11 to the first conveyance route R1. Further, the conveying roller pairs 19, 22, 23 and 25 rotate in the normal direction while holding the sheet 16, and thus the sheet 16 is conveyed along the first conveyance route R1. In a case where the sheet 16 passes through the recording position P1, the sheet 16 is conveyed in a first direction D1 (frontward).

The conveying unit 15 performs the second conveyance as follows; first, in a case where the rear end of the sheet 16 conveyed along the first conveyance route R1 passes through the branching point X1, the control unit 40 moves the flap 31 from the retracted position to the entered position in response to the signal from the sheet sensor 30 switching from the ON signal to the OFF signal. Then, under the control of the control unit 40, the conveying roller pairs 19, 22, 23, 25 and 26 rotate in a direction opposite to the normal direction. As a result, the sheet 16 is conveyed along the first conveyance route R1 in a second direction D2 (rearward) opposite to the first direction D1, and is returned to the first conveyance route R1 via the branching point X1 and the second conveyance route R2. After the sheet 16 conveyed in the second direction D2 has entered the second conveyance route R2, the controller 40 moves the flap 31 from the entered position to the retracted position. The sheet 16 returned from the second conveyance route R2 to the first conveyance route R1 passes through the branching point X1, and is then conveyed to the sheet discharge tray 13 while being held by the conveying roller pairs 19, 22, 23 and 25 which rotate in the normal direction.

As depicted in FIG. 3, the control unit 40 includes a CPU 41, a ROM 42 and a RAM 43. The CPU 41 is an example of a “controller”. The ROM 42 stores a program and/or data with which the CPU 41 performs various kinds of control. The RAM 43 temporarily stores data to be used in a case where the CPU 41 executes the program.

The control unit 40 is electrically connected to the conveying unit 15, the recording unit 21, the cutting unit 24, the sheet sensor 30 and the flap 31. The control unit 40 is also electrically connected to an external device (personal computer, etc.) 100.

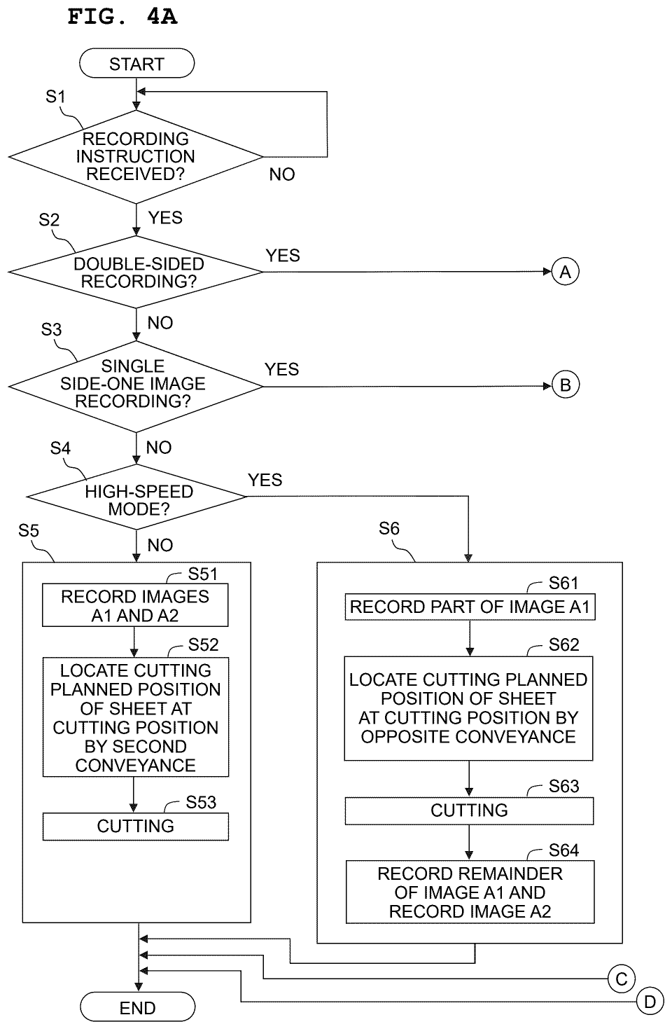

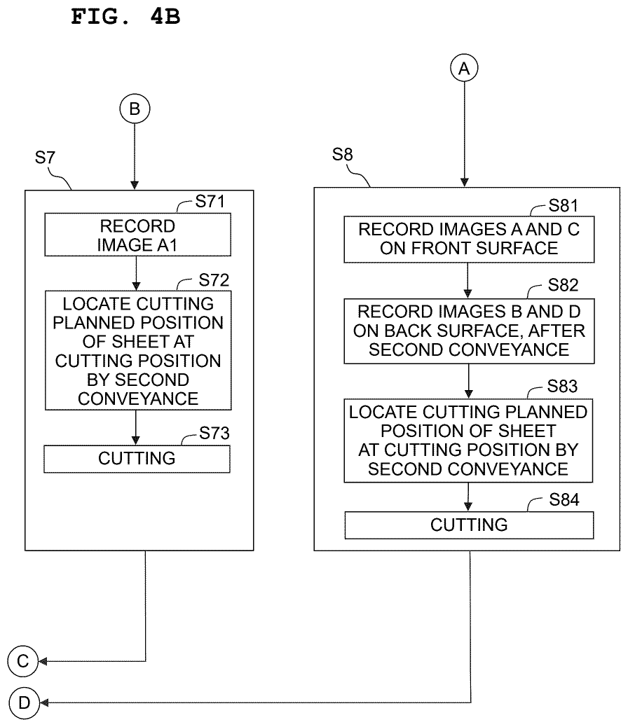

Next, the program executed by the CPU 41 will be described, with reference to FIG. 4A and FIG. 4B.

The CPU 41 first determines whether a recording instruction has been received from the external device 100 (step S1). In a case where the CPU 41 determines that the recording instruction has not been received from the external device 100 (step S1: NO), the CPU 41 repeats the process of step S1.

In a case where the CPU 41 determines that the recording instruction has been received from the external device 100 (step S1: YES), the CPU 41 determines whether the recording instruction indicates double-sided recording (step S2). The double-sided recording means recording in which an image is recorded on both the front surface and the back surface of the sheet 16. On the other hand, single-sided recording means recording in which an image is recorded on the front surface of the sheet 16, but an image is not recorded on the back surface of the sheet 16.

In a case where the controller 40 determines that the recording instruction indicates the double-sided recording (step S2: YES), the CPU 41 executes control of step S8 and then ends the program.

In a case where the CPU 41 determines that the recording instruction does not indicate the double-sided recording (i.e., indicates the single-sided recording) (step S2: NO), the CPU 41 determines whether the recording instruction indicates single side-one image recording (step S3). The single side-one image recording means recording in which an image is recorded on the front surface of the first half part of the sheet 16, and in which no image is recorded on the front surface of the second half part of the sheet 16. On the other hand, single side-two images recording means recording in which an image is recorded on the front surface of the first half part and in which an image is recorded on the front surface of the second half part of the sheet 16.

In a case where the CPU 41 determines that the recording instruction indicates the single side-one image recording (step S3: YES), the CPU 41 executes control of step S7 and then ends the program.

In a case where the CPU 41 determines that the recording instruction does not indicate the single side-one image recording (i.e., indicates the single side-two images recording) (step S3: NO), the CPU 41 determines whether a recording mode indicated by the recording instruction is a high-speed mode (step S4). The recording mode includes the high-speed mode and a normal mode of which recording speed is lower than the recording speed of the high-speed mode. The high-speed mode is an example of a “first mode”, and the normal mode is an example of a “second mode”.

In a case where the CPU 41 determines that the recording mode indicated by the recording instruction is the high-speed mode (step S4: YES), the CPU 41 executes the control of step S6 and then ends the program.

In a case where the CPU 41 determines that the recording mode indicated by the recording instruction is not the high-speed mode (that is, the normal mode) (step S4: NO), the CPU 41 executes the control of step S5 and then ends the program.

Next, the control of each of steps S5 to S8 will be described.

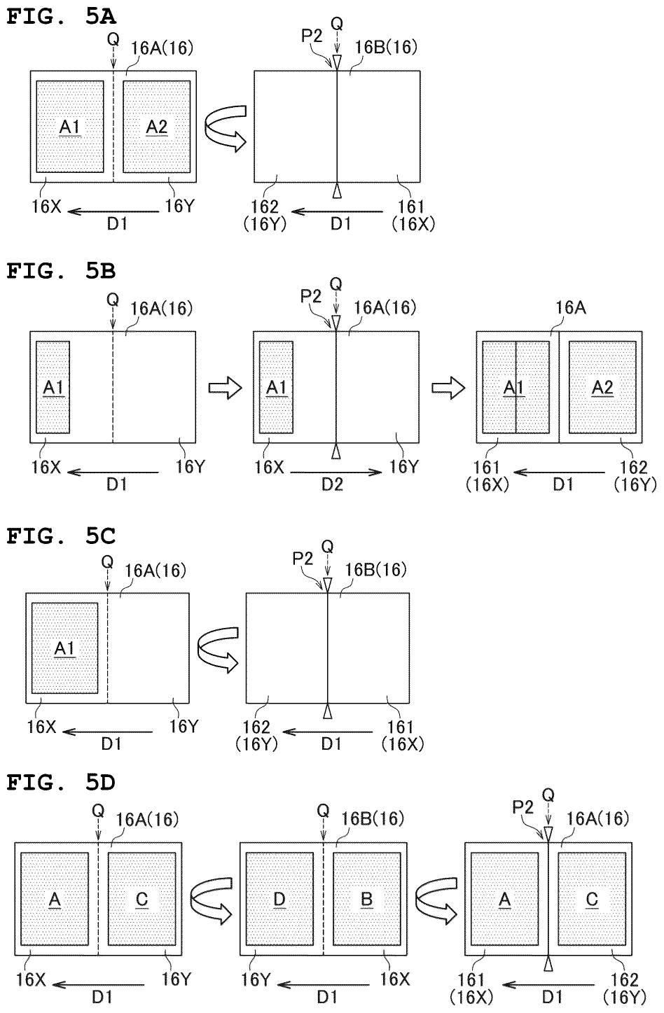

The control of step S5 is a control for generating a first sheet piece 161 being a first half part 16X, of the sheet 16, on a front surface 16A of which an image A1 is recorded, and a second sheet piece 162 being a second half part 16Y, of the sheet 16, on a front surface 16A of which an image A2 is recorded, as depicted in FIG. 5A. The control of step S5 is an example of a “first control”. The first half part 16X is a part located downstream in the first direction D1 at the time of the recording performed first on the sheet 16. The second half part 16Y is a part located upstream in the first direction D1 at the time of the recording performed first on the sheet 16. The first half part 16X is an example of a “first medium”, and the second half part 16Y is an example of a “second medium”. The first sheet piece 161 is an example of a “first recorded item”, and the second sheet piece 162 is an example of a “second recorded item”. The image A1 is an example of a “first image”, and the image A2 is an example of a “second image”.

In step S5, the CPU 41 first causes the conveying unit 15 to perform the first conveyance so as to convey one sheet 16, among the plurality of sheets 16 accommodated in the sheet feed tray 11, to the recording position P1 (see FIG. 2). Then, the CPU 41 causes the recording unit 21 to record the image A1 on the front surface 16A of the first half part 16X and to record the image A2 on the front surface 16A of the second half part 16Y, while causing the conveying unit 15 to convey the sheet 16 in the first direction D1 (step S51: first recording process). After step S51, the CPU 41 causes the conveying unit 15 to perform the second conveyance for causing the conveying unit 15 to convey the sheet 16 so that a cutting planned position Q of the sheet 16 is located at the cutting position P2 (step S52: first conveying process). The cutting planned position Q is a position along a width direction (left-right direction) of a sheet 16 which passes through the center in the first direction D1 (the direction along the first conveyance route R1) of the sheet 16. After step S52, the CPU 41 causes the cutting unit 24 to cut the sheet 16 (step S53: first cutting process). This generates the first sheet piece 161 and the second sheet piece 162. In this situation, the first sheet piece 161 is in a state that the back surface 16B of the first sheet piece 161 faces upward, and the second sheet piece 162 is in a state that the back surface 16B of the second sheet piece 162 faces upward; and the first sheet piece 161 is located upstream of the second sheet piece 162 in the first direction D1. After step S53, the first sheet piece 161 and the second sheet piece 162 are conveyed in the first direction D1 by the conveying unit 15 and received by the sheet discharge tray 13 (see FIG. 2).

The control of step S6 is a control for generating a first sheet piece 161 being the first half part 16X on the front surface 16A of which the image A1 is recorded, and a second sheet piece 162 being the second half part 16Y on the front surface 16A of which the image A2 is recorded, as depicted in FIG. 5B. In this control, the first sheet piece 161 is an example of the “first recorded item”, and the second sheet piece 162 is an example of the “second recorded item”. The image A1 is an example of a “first image”, and image A2 is an example of a “second image”. The control of step S6 is a control, different from the control of step S5 (first control), for generating the first sheet piece 161 and the second sheet piece 162 same as or similar to the first sheet piece 161 and the second sheet piece 162 generated in step S5. The control of step S6 is an example of a “second control”.

In step S6, the CPU 41 first causes the conveying unit 15 to perform the first conveyance so as to convey the one sheet 16 accommodated in the sheet feed tray 11 to the recording position P1 (see FIG. 2). Then, the CPU 41 causes the recording unit 21 to record a part of the image A1 on the front surface 16A of the first half part 16X while causing the conveying unit 15 to convey the sheet 16 in the first direction D1 (step S61: second recording process). After step S61, the CPU 41 causes the conveying unit 15 to convey the sheet 16 in the second direction D2 (to convey the sheet 16 in the opposite direction) so that the cutting planned position Q of the sheet 16 is located at the cutting position P2 (step S62: second conveying process). After step S62, the CPU 41 causes the cutting unit 24 to cut the sheet 16 (step S63: second cutting process). With this, the first half part 16X and the second half part 16Y are separated from each other. After step S63, the CPU 41 causes the conveying unit 15 to convey the first half part 16X and the second half part 16Y in the first direction D1, thereby conveying the first half part 16X and the second half part 16Y to the recording position P1 (see FIG. 2), and causes the recording unit 21 to record the remainder of the image A1 on the front surface 16A of the first half part 16X and to record the image A2 on the front surface 16A of the second half part 16Y (step S64: third recording process). This generates the first sheet piece 161 and the second sheet piece 162. In this situation, the first sheet piece 161 is in a state that the front surface 16A of the first sheet piece 161 faces upward, and the second sheet piece 162 is in a state that the front surface 16A of the second sheet piece 162 faces upward; and the first sheet piece 161 is located downstream of the second sheet piece 162 in the first direction D1. After step S64, the first sheet piece 161 and the second sheet piece 162 are conveyed in the first direction D1 by the conveying unit 15 and are received by the sheet discharge tray 13 (see FIG. 2).

The control of step S7 is a control for generating a first sheet piece 161 being the first half part 16X on the front surface 16A of which image A1 is recorded, and a second sheet piece 162 being the second half part 16Y on which no image is recorded, as depicted in FIG. 5C. In this control, the first sheet piece 161 is an example of a “third recorded item”, and the image A1 is an example of a “third image”. The control of step S7 is a control different from the control of step S5 (first control), and is an example of a “second control” for generating the third recorded item being the first medium on which the third image is recorded, and the second medium on which no image is recorded.

In step S7, the CPU 41 first causes the conveying unit 15 to perform the first conveyance so as to convey the one sheet 16 accommodated in the sheet feed tray 11 to the recording position P1 (see FIG. 2). After that, the CPU 41 causes the recording unit 21 to record the image A1 on the front surface 16A of the first half part 16X while causing the conveying unit 15 to convey the sheet 16 in the first direction D1 (step S71: second recording process). After step S71, the CPU 41 causes the conveying unit 15 to perform the second conveyance so as to convey the sheet 16 so that the cutting planned position Q of the sheet 16 is located at the cutting position P2 (step S72: second conveying process). After step S72, the CPU 41 causes the cutting unit 24 to cut the sheet 16 (step S73: second cutting process). This generates the first sheet piece 161 and the second sheet piece 162. In this situation, the first sheet piece 161 is in a state that the back surface 16B of the first sheet piece 161 faces upward, and the second sheet piece 162 is in a state that the back surface 16B of the second sheet piece 162 faces upward; and the first sheet piece 161 is located upstream of the second sheet piece 162 in the first direction D1. After step S73, the first sheet piece 161 and the second sheet piece 162 are conveyed in the first direction D1 by the conveying unit 15 and are received by the sheet discharge tray 13 (see FIG. 2).

The control of step S8 is a control for generating a first sheet piece 161 being the first half part 16X which has the image A recorded on the front surface 16A and the image B recorded on the back surface 16B, and a second sheet piece 162 being the second half part 16Y which has the image C recorded on the front surface 16A and the image D recorded on the back surface 16B, as depicted in FIG. 5D. In this control, the first sheet piece 161 is an example of a “third recorded item”, and the second sheet piece 162 is an example of a “fourth recorded item”. The control of step S8 is a control different from the control of step S5 (first control) and is a control for generating the third recorded item being the first medium which has the image A recorded on the first surface and the image B recorded on the second surface, and the fourth recorded item being the second medium which has the image C recorded on the first surface and the image D recorded on the second surface. The control of step S8 is an example of a “second control”.

In step S8, the CPU 41 first causes the conveying unit 15 to perform the first conveyance so as to convey one sheet 16 accommodated in the sheet feed tray 11 to the recording position P1 (see FIG. 2). Then, the CPU 41 causes the recording unit 21 to record the image A on the front surface 16A of the first half part 16X and to record the image C on the front surface 16A of the second half part 16Y, while causing the conveying unit 15 to convey the sheet 16 in the first direction D1 (step S81: first surface-recording process). After step S81, the CPU 41 causes the conveying unit 15 to perform the second conveyance and causes the recording unit 21 to record the image B on the back surface 16B of the first half part 16X and to record the image D on the back surface 16B of the second half part 16Y (step S82: second surface-recording process). After step S82, the CPU 41 causes the conveying unit 15 to perform the second conveyance to convey the sheet 16 by the conveying unit 15 so that the cutting planned position Q of the sheet 16 is located at the cutting position P2 (step S83: second conveying process). After step S83, the CPU 41 causes the cutting unit 24 to cut the sheet 16 (step S84: second cutting process). This generates the first sheet piece 161 and the second sheet piece 162. At this time, the first sheet piece 161 is in a state that the front surface 16A of the first sheet piece 161 faces upward, and the second sheet piece 162 is in a state that the front surface 16A of the second sheet piece 162 faces upward; and the first sheet piece 161 is located downstream of the second sheet piece 162 in the first direction D1. After step S84, the first sheet piece 161 and the second sheet piece 162 are conveyed in the first direction D1 by the conveying unit 15 and are received by the sheet discharge tray 13 (see FIG. 2).

As described above, according to the present embodiment, the cutting position P2 is located upstream of the recording unit 21 in the first conveyance route R1 (see FIG. 2). In this configuration, the CPU 41 can execute the first control (step S5) to generate the first sheet piece 161 being the first half part 16X on which the image A1 is recorded and the second sheet piece 162 being the second half part 16Y on which the image A2 is recorded, as depicted in FIG. 5A. In the first control (step S5), the images A1 and A2 are recorded (step S51) before the cutting (step S53). In this case, since the recording medium has not undergone any positional deviation due to the cutting in a case that the recording is performed, degradation of quality of the image is reduced.

In a case where the CPU 41 determines that the high-speed mode has been selected (step S4: YES), the CPU 41 can execute the second control (step S6), which is different from the first control (step S5), in order to generate the first sheet piece 161 being the first half part 16X on which the image A1 is recorded and the second sheet piece 162 being the second half part 16Y on which the image A2 is recorded, as depicted in FIG. 5B. In a case where the user wishes to prioritize the recording speed, the high-speed mode is selected. In this case, by executing the second control (step S6) instead of the first control (step S5), the recording speed can be increased, and the recording desired by the user can be realized.

In the first conveying process (step S52), the CPU 41 causes the conveying unit 15 to perform the second conveyance. In a case where the CPU 41 causes the conveying unit 15 to perform an opposite conveyance (to convey the sheet 16 in the second direction D2) in the first conveying process (step S52), the conveying motor needs to be rotated in the opposite direction, which might cause rattling in the drive of the conveying unit 15. In contrast, in the present configuration, the second conveyance is performed in the first conveying process (step S52), and since the conveying motor is not required to be rotated in the opposite direction at a timing when the cutting planed position Q is positioned at the cutting position P2, the rattling does not occur in the drive of the conveying unit 15. This in turn improves the precision in conveyance (and also improves the precision in cutting and/or the precision in recording).

As depicted in FIG. 5C, the CPU 41 can execute the second control (step S7), which is different from the first control (step S5), in order to generate the first sheet piece 161 being the first half part 16X on the front surface 16A of which the image A1 is recorded and the second sheet piece 162 being the second half part 16Y on which no image is recorded. In the second conveying process (step S72) of the second control (step S7), the CPU 41 causes the conveying unit 15 to perform the second conveyance, like the first conveying process (step S52) of the first control (step S5). In other words, even in a case where no image is to be recorded in the second half part 16Y (FIG. 5C), the CPU 41 performs the second conveyance like a case where an image is to be recorded in both the first half part 16X and the second half part 16Y (FIG. 5A). As a result, the orientation of the surfaces, respectively, of the sheet pieces 161 and 162 after the sheet pieces 161 and 162 are discharged to the sheet discharge tray 13 are made the same in both of the above-described cases (FIGS. 5A and 5C), thereby eliminating the need for the user to unify the orientation of the surfaces of the sheet pieces 161 and 162 and improving the workability.

As depicted in FIG. 5D, the CPU 41 can execute the second control (step S8), which is different from the first control (step S5), in order to generate the first sheet piece 161 being the first half part 16X which has the image A recorded on the front surface 16A and the image B recorded on the back surface 16B, and the second sheet piece 162 being the second half part 16Y which has the image C recorded on the front surface 16A and the image D recorded on the back surface 16B. In the second control (step S8), the CPU 41 causes the conveying unit 15 to perform the second conveyance in the second conveying process (step S83) after the second surface-recording process (step S82). In this manner, also in a case that the double-sided recording is performed, the precision in conveyance (and further the precision in cutting and/or the precision in recording) can be improved by causing the CPU 41 to perform the second conveyance in the conveying process of locating the cutting planned position Q at the cutting position P2, like the single-sided recording (step S5). Furthermore, also in a case that the double-sided recording is performed, since the recording of the image (steps S81 and S82) is performed before the cutting (step S84) like a case that the single-sided recording is performed (step S5), the degradation of the quality of the image is reduced.

The branching point X1 is located upstream of the recording unit 21 in the first conveyance route R1 (see FIG. 2). In this case, the second conveyance route R2 can be made short as compared with a case where the branching point X1 is located downstream of the recording unit 21 in the first conveyance route R1.

The branching point X1 is located downstream of the cutting position P2 in the first conveyance route R1 (see FIG. 2). In this case, as compared to a case where the branching point X1 is located upstream of the cutting position P2 in the first conveyance route R1, there is no need to increase the curvature of the second conveyance route R2 in the vicinity of the joining point X2 in order to smoothly convey the sheet 16 from the second conveyance route R2 to the first conveyance route R1.

The distance from the recording unit 21 to the cutting position P2 in the first conveyance route R1 is smaller than the half of the length along the first conveyance route R1 of the sheet 16 of which length along the first conveyance route R1 is the greatest among the sheets 16 of the plurality of sizes which can be accommodated in the sheet feed tray 11. In this case, the printer 1 can be made compact.

The distance from the recording unit 21 to the cutting position P2 in the first conveyance route R1 is 182 mm or less. In this case, the printer 1 can be made more compact in an ensured manner.

Next, a second embodiment of the present disclosure will be described.

In the first conveying process (step S52) of the first embodiment, the CPU 41 causes the conveying unit 15 to perform the second conveyance. In contrast, in the first conveying process (step S52) of the second embodiment, the CPU 41 causes the conveying unit 15 to perform the opposite conveyance (to convey the sheet 16 in the second direction D2, i.e., from the downstream toward the upstream in the first conveyance route R1).

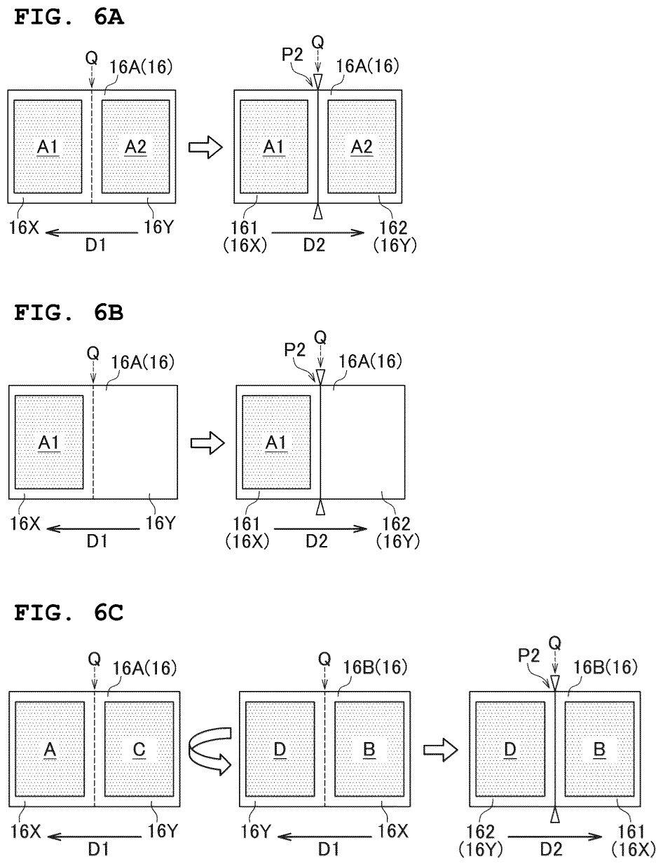

First control (step S5) of the second embodiment is same as or similar to the first control of the first embodiment, except for the first conveying process (step S52) (see FIG. 5A and FIG. 6A). In the second embodiment, as depicted in FIG. 6A, after the first recording process (step S51), the CPU 41 causes the conveying unit 15 to perform the opposite conveyance to convey the sheet 16 by the conveying unit 15 so that the cutting planned position Q of the sheet 16 is located at the cutting position P2 (step S52: first conveying process). In the second embodiment, after the first cutting process (step S53), the first sheet piece 161 is in a state that the front surface 16A of the first sheet piece 161 faces upward, and the second sheet piece 162 is in a state that the front surface 16A of the second sheet piece 162 faces upward; and the first sheet piece 161 is located downstream of the second sheet piece 162 in the first direction D1.

In a case where the conveyance in the opposite direction is performed in the first conveying process (step S52) as in the second embodiment, the conveyance distance is short and the time required for the conveying process can be shortened, as compared with the case where the second conveyance is performed in the first conveying process (step S52) as in the first embodiment.

In the first embodiment, the CPU 41 causes the conveying unit 15 to perform the second conveyance in the second conveying process (step S72). In contrast, in the second embodiment, the CPU 41 causes, in the second conveying process (step S72), the conveying unit 15 to perform the opposite conveyance (to convey the sheet 16 in the second direction D2, i.e., from the downstream toward the upstream in the first conveyance route R1).

The second control (step S7) of the second embodiment is same as or similar to the second control of the first embodiment, except for the second conveying process (step S72) (see FIG. 5C and FIG. 6B). In the second embodiment, as depicted in FIG. 6B, after the second recording process (step S71), the CPU 41 causes the conveying unit 15 to perform the opposite conveyance and causes the conveying unit 15 to convey the sheet 16 so that the cutting planned position Q of the sheet 16 is located at the cutting position P2 (step S72: second conveying process). In the second embodiment, after the second cutting process (step S73), the first sheet piece 161 is in a state that the front surface 16A of the first sheet piece 161 faces upward, and the second sheet piece 162 is in a state that the front surface 16A of the second sheet piece 162 faces upward; and the first sheet piece 161 is located downstream of the second sheet piece 162 in the first direction D1.

In a case where the conveyance in the opposite direction is performed in the second conveying process (step S72) as in the second embodiment, the conveyance distance is short and the time required for the conveying process can be shortened as compared with a case where the second conveyance is performed in the second conveying process (step S72) as in the first embodiment.

In the first embodiment, the CPU 41 causes the conveying unit 15 to perform the second conveyance in the second conveying process (step S83). In contrast, in the second embodiment, the CPU 41 causes the conveying unit 15 to perform the opposite conveyance (to convey the sheet 16 in the second direction D2, i.e., from the downstream toward the upstream of the first conveyance route R1), in the second conveying process (step S83).

The second control (step S8) of the second embodiment is same as or similar to the second control of the first embodiment, except for the second conveying process (step S83) (see FIG. 5D and FIG. 6C). In the second embodiment, as depicted in FIG. 6C, after the second surface-recording process (step S82), the CPU 41 causes the conveying unit 15 to perform the opposite conveyance and causes the conveying unit 15 to convey the sheet 16 so that the cutting planned position Q of the sheet 16 is located at the cutting position P2 (step S83: second conveying process). In the second embodiment, after the second cutting process (step S84), the first sheet piece 161 is in a state that the back surface 16B of the first sheet piece 161 faces upward, and the second sheet piece 162 is in a state that the back surface 16B of the second sheet piece 162 faces upward; and the first sheet piece 161 is located upstream of the second sheet piece 162 in the first direction D1.

In the case where the conveyance in the opposite direction is performed in the second conveying process (step S83) as in the second embodiment, the conveyance distance is short and the time required for the conveying process can be shortened as compared with the case where second conveyance is performed in the second conveying process (step S83) as in the first embodiment. Further, also in a case that the double-sided recording is performed, since the recording of the image (steps S81 and S82) is performed before the cutting (step S84) like a case that the single-sided recording is performed, the degradation of the quality of the image is reduced.

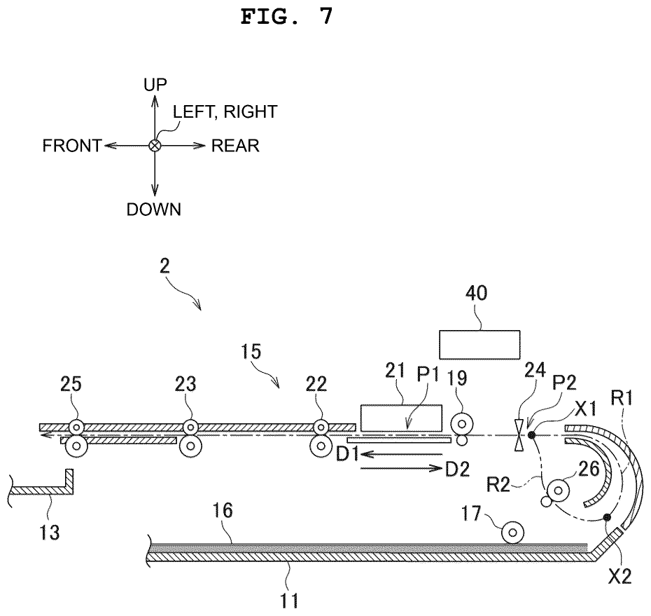

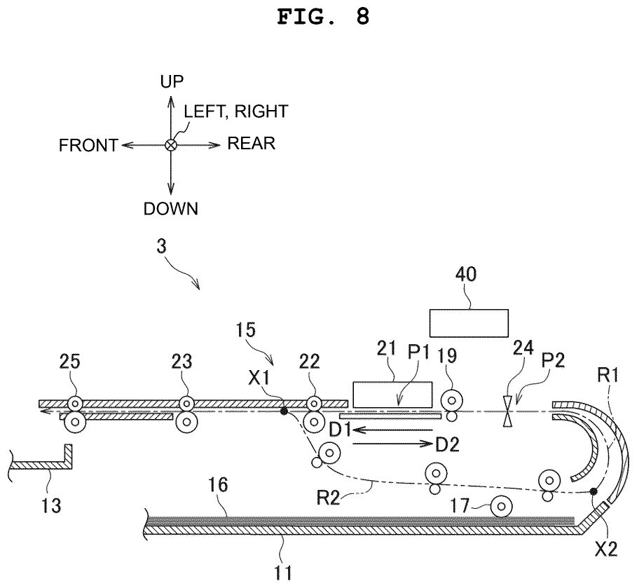

Next, a third embodiment of the present disclosure will be described, with reference to FIG. 7.

A printer 2 according to the third embodiment has the same configuration as the configuration of the printer 1 of the first embodiment, except for the position of the branching point X1. In the third embodiment, the branching point X1 is located upstream of the cutting position P2 in the first conveyance route R1. In this case, the second conveyance route R2 can be made further short.

Next, a fourth embodiment of the present disclosure will be described, with reference to FIG. 8.

A printer 3 according to the fourth embodiment has the same configuration as the configuration of the printer 1 of the first embodiment, except for the position of the branching point X1. In the fourth embodiment, the branching point X1 is located downstream of the recording unit 21 in the first conveyance route R1. In a case where the branching point X1 is located upstream of the recording unit 21 in the first conveyance route R1 and where the sheet 16 is conveyed in the second direction D2 toward the branching point X1, the sheet 16 might contact a component (a sensor, a corrugated plate, etc.) disposed in the vicinity of the recording unit 21 and might cause a jam. In the present configuration, occurrence of such problem can be reduced.

### (Modification)

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

For example, although the first conveyance route and the second conveyance route are included in the above-described embodiments, the second conveyance route may be omitted.

The recording medium is not limited to the sheet (that is, paper sheet), and may be cloth, a resin member, etc.

The recording part is not limited to the recording part of the ink-jet system, and may also be a recording part of the laser system, the thermal transfer system, etc.

The present disclosure is not limited to being applicable to the printer, and may be applicable also to a facsimile, a copying machine, a multi-function peripheral, etc.

The program according to the present disclosure may be distributed by being recorded on a removable storage medium such as a flexible disc, etc., a fixed storage medium such as a hard disk, etc., or via a communication line.

What is claimed is:

1. A recording apparatus comprising:
a recorder configured to record an image on a recording medium;
a cutter configured to cut the recording medium at a cutting position so as to divide the recording medium into a first medium and a second medium;
a conveyor configured to convey the recording medium toward the recorder along a first conveyance route; and
a controller, wherein:
the cutting position is located upstream of the recorder in the first conveyance route;
the controller is configured to execute first control so as to generate a first recorded item being the first medium on which a first image is recorded and a second recorded item being the second medium on which a second image is recorded; and
the first control includes:
a first recording process of causing the recorder to record the first image and the second image on a first objective recording medium being the recording medium which is single and which is an object of the first control;
a first conveying process of causing the conveyor to convey the first objective recording medium so that a cutting planned position of the first objective recording medium is located at the cutting position after the first recording process; and
a first cutting process of causing the cutter to cut the first objective recording medium after the first conveying process.

2. The recording apparatus according to claim 1, wherein:
the controller is configured to:
determine which one of a first mode and a second mode has been selected, the second mode having a recording speed lower than a recording speed of the first mode; and
in a case where the controller determines that the first mode has been selected, the controller is configured to execute second control different from the first control so as to generate the first recorded item and the second recorded item; and
the second control includes:
a second recording process of causing the recorder to record at least a part of the first image on a second objective recording medium being the recording medium which is single and which is an object of the second control;
a second conveying process of causing the conveyor to convey the second objective recording medium so that the cutting planned position of the second objective recording medium is located at the cutting position after the second recording process;
a second cutting process of causing the cutter to cut the second objective recording medium after the second conveying process; and
a third recording process of causing the recorder to record the second image on the second medium obtained by cutting the second objective recording medium, after the second cutting process.

3. The recording apparatus according to claim 1, wherein:
the recording medium has a first surface and a second surface opposite to the first surface;
the conveyor is configured to perform:
first conveyance of conveying the recording medium along the first conveyance route so that the first surface faces the recorder; and
second conveyance of conveying the recording medium from the first conveyance route to the first conveyance route via a second conveyance route so that a state that the first surface faces the recorder is changed to a state that the second surface faces the recorder, the second conveyance route branching from the first conveyance route at a branching point in the first conveyance route and joining the first conveyance route at a joining point which is located upstream of the branching point and the cutting position in the first conveyance route; and
in the first conveying process, the controller is configured to cause the conveyor to perform the second conveyance.

4. The recording apparatus according to claim 3, wherein:
the controller is configured to execute second control different from the first control so as to generate a third recorded item being the first medium on which a third image is recorded and the second medium on which no image is recorded;
the second control includes:
a second recording process of causing the recorder to record the third image on a second objective recording medium being the recording medium which is single and which is an object of the second control;
a second conveying process of causing the conveyor to convey the second objective recording medium so that the cutting planned position of the second objective recording medium is located at the cutting position after the second recording process; and
a second cutting process of causing the cutter to cut the second objective recording medium after the second conveying process; and
in the second conveying process, the controller is configured to cause the conveyor to perform the second conveyance.

5. The recording apparatus according to claim 3, wherein:
the controller is configured to execute second control different from the first control so as to generate a third recorded item being the first medium which has an image A recorded on the first surface and an image B recorded on the second surface, and a fourth recorded item being the second medium which has an image C recorded on the first surface and an image D recorded on the second surface;
the second control includes:
a first surface-recording process of causing the recorder to record the image A and the image C on the first surface of a second objective recording medium being the recording medium which is single and which is an object of the second control;
a second surface-recording process of causing the conveyor to perform the second conveyance after the first surface-recording process, and of causing the recorder to record the image B and the image D on the second surface of the second objective recording medium;
a second conveying process of causing the conveyor to convey the second objective recording medium so that the cutting planned position of the second objective recording medium is located at the cutting position after the second surface-recording process; and
a second cutting process of causing the cutter to cut the second objective recording medium after the second conveying process; and
in the second conveying process, the controller is configured to cause the conveyor to perform the second conveyance.

6. The recording apparatus according to claim 3, wherein the branching point is located upstream of the recorder in the first conveyance route.

7. The recording apparatus according to claim 6, wherein the branching point is located downstream of the cutting position in the first conveyance route.

8. The recording apparatus according to claim 6, wherein the branching point is located upstream of the cutting position in the first conveyance route.

9. The recording apparatus according to claim 3, wherein the branching point is located downstream of the recorder in the first conveyance route.

10. The recording apparatus according to claim 1, wherein the first conveying process includes causing the conveyor to convey the first objective recording medium along the first conveyance route from downstream toward upstream of the first conveyance route until the cutting planned position of the first objective recording medium is located at the cutting position.

11. The recording apparatus according to claim 10, wherein:
the controller is configured to execute second control different from the first control so as to generate a third recorded item being the first medium on which a third image is recorded and the second medium on which no image is recorded;
the second control includes:
a second recording process of causing the recorder to record the third image on a second objective recording medium being the recording medium which is single and which is an object of the second control;
a second conveying process of causing the conveyor to convey the second objective recording medium so that the cutting planned position of the second objective recording medium is located at the cutting position after the second recording process; and
a second cutting process of causing the cutter to cut the second objective recording medium after the second conveying process; and
the second conveying process includes causing the conveyor to convey the second objective recording medium along the first conveyance route from downstream toward upstream of the first conveyance route until the cutting planned position of the second objective recording medium is located at the cutting position.

12. The recording apparatus according to claim 10, wherein:
the recording medium has a first surface and a second surface opposite to the first surface;
the conveyor is configured to perform:
first conveyance of conveying the recording medium along the first conveyance route so that the first surface faces the recorder; and
second conveyance of conveying the recording medium from the first conveyance route to the first conveyance route via a second conveyance route so that a state that the first surface faces the recorder is changed to a state that the second surface faces the recorder, the second conveyance route branching from the first conveyance route at a branching point in the first conveyance route and joining the first conveyance route at a joining point which is located upstream of the branching point and the cutting position in the first conveyance route;
the controller is configured to execute second control different from the first control so as to generate a third recorded item being the first medium which has an image A recorded on the first surface and an image B recorded on the second surface, and a fourth recorded item being the second medium which has an image C recorded on the first surface and an image D recorded on the second surface;
the second control includes:
a first surface-recording process of causing the recorder to record the image A and the image C on the first surface of a second objective recording medium being the recording medium which is single and which is an object of the second control;
a second surface-recording process of causing the conveyor to perform the second conveyance after the first surface-recording process, and of causing the recorder to record the image B and the image D on the second surface of the second objective recording medium;
a second conveying process of causing the conveyor to convey the second objective recording medium so that the cutting planned position of the second objective recording medium is located at the cutting position after the second surface-recording process; and
a second cutting process of causing the cutter to cut the second objective recording medium after the second conveying process; and
the second conveying process includes causing the conveyor to convey the second objective recording medium along the first conveyance route from downstream toward upstream of the first conveyance route until the cutting planned position of the second objective recording medium is located at the cutting position.

13. The recording apparatus according to claim 1, further comprising a container which is configured to accommodate a plurality of the recording medium having mutually different lengths along the first conveyance route,
wherein a distance from the recorder to the cutting position in the first conveyance route is smaller than a half of a length of a recording medium having the length which is greatest among the plurality of the recording medium.

14. The recording apparatus according to claim 1, wherein a distance from the recorder to the cutting position in the first conveyance route is 182 mm or less.

15. A control method of a recording apparatus, the recording apparatus including:
a recorder configured to record an image on a recording medium;
a cutter configured to cut the recording medium at a cutting position so as to divide the recording medium into a first medium and a second medium; and
a conveyor configured to convey the recording medium toward the recorder along a first conveyance route,
wherein the cutting position is located upstream of the recorder in the first conveyance route,
the control method comprising executing first control so as to generate a first recorded item being the first medium on which a first image is recorded and a second recorded item being the second medium on which a second image is recorded,
wherein the first control includes:
a first recording process of causing the recorder to record the first image and the second image on a first objective recording medium being the recording medium which is single and which is an object of the first control;
a first conveying process of causing the conveyor to convey the first objective recording medium so that a cutting planned position of the first objective recording medium is located at the cutting position after the first recording process; and
a first cutting process of causing the cutter to cut the first objective recording medium after the first conveying process.

16. A non-transitory and computer-readable medium storing a program executable by a controller of a recording apparatus, the recording apparatus including:
a recorder configured to record an image on a recording medium;
a cutter configured to cut the recording medium at a cutting position so as to divide the recording medium into a first medium and a second medium;
a conveyor configured to convey the recording medium toward the recorder along a first conveyance route; and
the controller,
wherein the cutting position is located upstream of the recorder in the first conveyance route,
the program is configured to cause the controller to execute first control so as to generate a first recorded item being the first medium on which a first image is recorded and a second recorded item being the second medium on which a second image is recorded,
wherein the first control includes:
a first recording process of causing the recorder to record the first image and the second image on a first objective recording medium being the recording medium which is single and which is an object of the first control;
a first conveying process of causing the conveyor to convey the first objective recording medium so that a cutting planned position of the first objective recording medium is located at the cutting position after the first recording process; and
a first cutting process of causing the cutter to cut the first objective recording medium after the first conveying process.
